(19) United States
(12) Patent Application Publication
(10) Pub. No.: US 2017/0126670 A1
(43) Pub. Date: May 4, 2017

(54) TIME INFORMATION BASED AUTHENTICATION METHOD, INTEGRATED CIRCUIT FILM, SIM CARD OR SD CARD

(71) Applicant: MXTRAN INC., Hsin Chu (TW)

(72) Inventors: Yvette E-Wen Lin, Hsinchu (TW); Chi-Hsuan Yen, Hsinchu (TW); Kuan-Hung Lu, Hsinchu (TW); Yu-Feng Chen, Hsinchu (TW); Jen-Ho Chang, Hsinchu (TW); Shu-Ching Huang, Hsinchu (TW)

(21) Appl. No.: 14/924,783

(22) Filed: Oct. 28, 2015

(51) Int. Cl. H04L 29/06; H04B 1/3816; H04W 12/06

(52) U.S. Cl. CPC H04L 63/0853; H04W 12/06; H04B 1/3816

(57) ABSTRACT

A time information based authentication method, an integrated circuit film or with a SIM card or a SD card are provided. The time information based authentication method comprises the following steps. A time information is obtained from a external device. A data is received from a memory unit of a security chip. An authentication code is generated according to the data and the time information.

### TECHNICAL FIELD

The disclosure relates in general to an authentication method in mobile device, an integrated circuit film or with a SIM card or a SD card, and more particularly to a time information based authentication method, an integrated circuit film and a SIM card or a SD card having a time information based authentication function.

### BACKGROUND

With the development of mobile device technology, varied services are provided on the mobile device. For example, the user can utilize the mobile device as a tool for performing payment service or secured services for access control or authentication purpose. In this situation, the authentication mechanisms on the mobile device become more and more important. The common authentication mechanisms, for example, the one-time password (OTP), time-based OTP, counter-based OTP or OATH challenge response algorithm (OCRA), are widely used.

### SUMMARY

The disclosure is directed to a time information based authentication method, an integrated circuit film, or with a SIM card or a SD card. The authentication code is generated according to a data and a time information which is obtained from an external device.

According to one embodiment, a time information based authentication method is provided. The time information based authentication method comprises the following steps. A time information is obtained from an external device. A data is received from a memory unit of a security chip. An authentication code is generated according to the data and the time information.

According to another embodiment, an integrated circuit is provided. The integrated circuit comprises a security chip. The security chip comprises a time information obtaining unit, a memory unit and an authentication unit. The time information obtaining unit is for obtaining a time information from the external device. The memory unit is for storing a data. The authentication unit is for generating an authentication code according to the data and the time information.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1A illustrates an integrated circuit film by showing a first surface according to an embodiment of the invention;

FIG. 1B illustrates the integrated circuit film by showing a second surface according to an embodiment of the invention;

FIG. 2 shows the integrated circuit film, a subscriber identity module (SIM) card and a mobile device according to an embodiment of the invention.

FIG. 3 shows a relation diagram among an integrated circuit film, a SIM card, a mobile device and a server according to an embodiment of the invention;

FIG. 4 is a schematic diagram of the security chip according to an embodiment of the invention;

FIG. 5 shows a flow chart of a time information based authentication method;

FIG. 6 shows a flow chart of step S101 according to an embodiment of the invention.

FIG. 7 is a schematic diagram of the time information obtaining unit and mobile according to an embodiment of the invention.

FIG. 8 is a schematic diagram of the SIM card according to an embodiment of the invention.

FIG. 9 is a schematic diagram of a secure digital (SD) card 600 according to an embodiment of the invention.

FIG. 10 shows the SD card and the mobile device according to an embodiment of the invention.

FIG. 11 shows a relation diagram among the security chip, the SD card, the mobile device and the server according to an embodiment of the invention.

### DETAILED DESCRIPTION

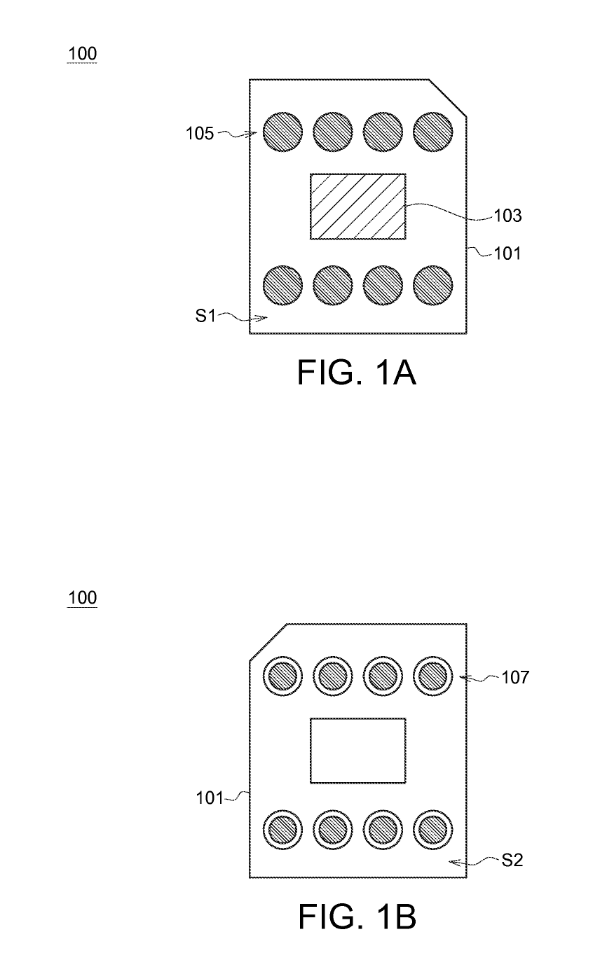

FIG. 1A illustrates an integrated circuit film 100 by showing a first surface S1 according to an embodiment of the invention. The integrated circuit film 100 includes a circuit board 101, a security chip 103, and a plurality of first pads 105. The first pads 105 are located on the first surface S1 of the circuit board 101. The security chip 103 is mounted on the first surface S1 of the circuit board 101.

FIG. 1B illustrates the integrated circuit film 100 by showing a second surface S2 according to an embodiment of the invention. The second surface S2 is opposite to the first surface S1. The integrated circuit film 100 further includes a plurality of second pads 107 located on the second surface S2 of the circuit board 101. Although the security chip 103 is mounted on the first surface S1 of the circuit board 101 as shown in FIG. 1A, the security chip 103 can also be mounted on the second surface S2 alternatively based on the function or the application of the integrated circuit film 100.

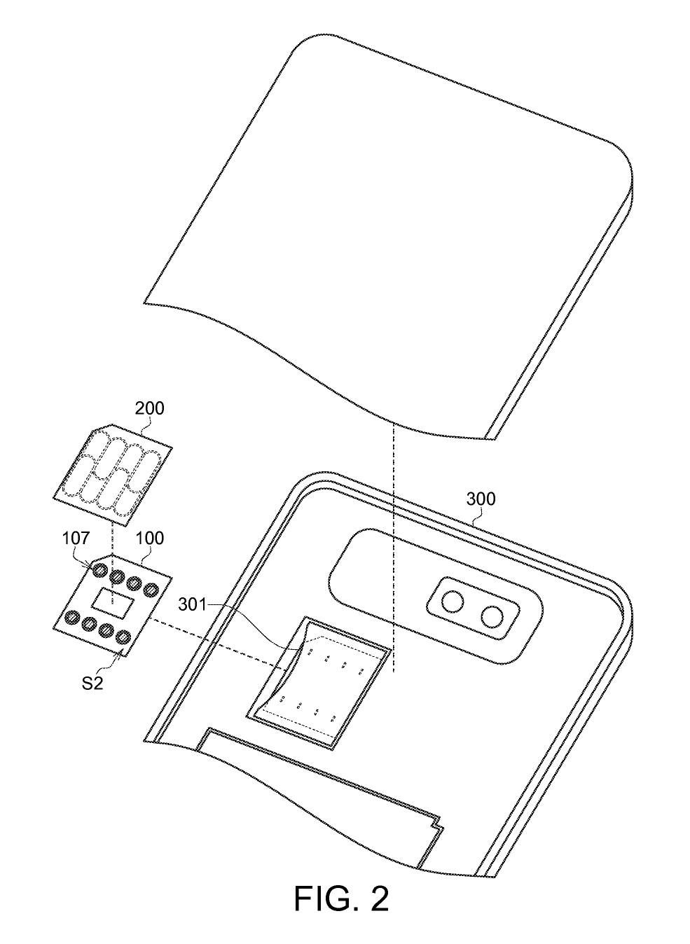

FIG. 2 shows the integrated circuit film 100, a subscriber-identity-module (SIM) card 200 and a mobile device 300 according to an embodiment of the invention. Please referring to FIG. 1A, FIG. 1B and FIG. 2, the first pads 105, for example, are used for connecting to the mobile device 300 while the second pads 107, for example, are used for connecting to the SIM card 200. The security chip 103 may communicate with the mobile device 300 through the first pads 105, and communicate with the SIM card 200 through the second pads 107. The SIM card 200 includes a memory unit which stores the personal information of an account holder, including his or her phone number, address book, text messages, and other data. The integrated circuit film 100 may be attached on the SIM card 200 and may be put into a SIM card slot 301 of the mobile device 300 along with the SIM card 200.

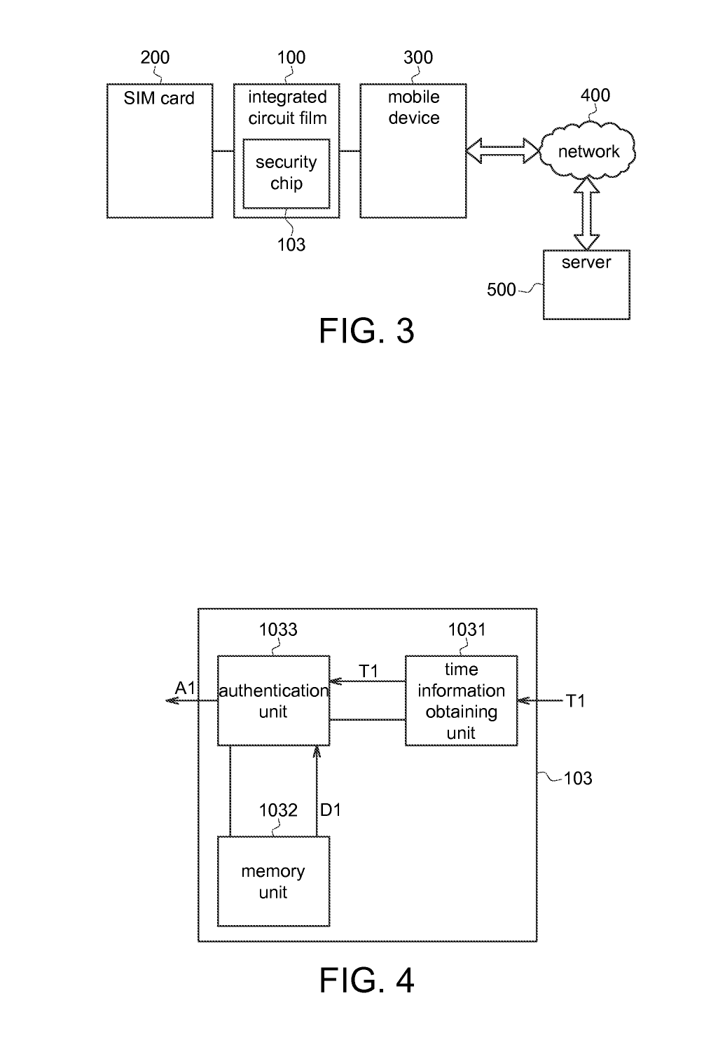

Please referring to FIG. 3, FIG. 3 shows a relation diagram among the integrated circuit film 100, the SIM card 200, the mobile device 300 and a server 500 according to an embodiment of the invention. The mobile device 300 may communicate with a server 500 through a network 400. The server 500 may be an authentication server. In one embodiment, the security chip 103 may generate an authentication code, and may send the authentication code to server 500 to perform an authentication procedure. In another embodiment, the security chip 103 may generate the authentication code, and may display on a screen of the mobile device 300. Then, the user may input the authentication code in a computer system (not shown) which is connected to the server 500, to perform the authentication procedure.

FIG. 4 is a schematic diagram of the security chip 103 according to an embodiment of the invention. The security chip 103 includes a time information obtaining unit 1031, a memory unit 1032 and an authentication unit 1033.

The time information obtaining unit 1031 is used for obtaining an information from the mobile device 300. For example, the time information obtaining unit 1031 may be a processing chip, a storage medium storing a plurality of program codes, and/or a circuit having a function of obtaining the information from the mobile device 300.

The memory unit 1032 is used for storing a data. For example, the memory unit 1032 may be a read only memory (ROM).

The authentication unit 1033 is used for processing the data and generating the data. For example, the authentication unit 1033 may be a processing chip, a storage medium storing a plurality of program codes, and/or a circuit having a function of processing the data and generating the data.

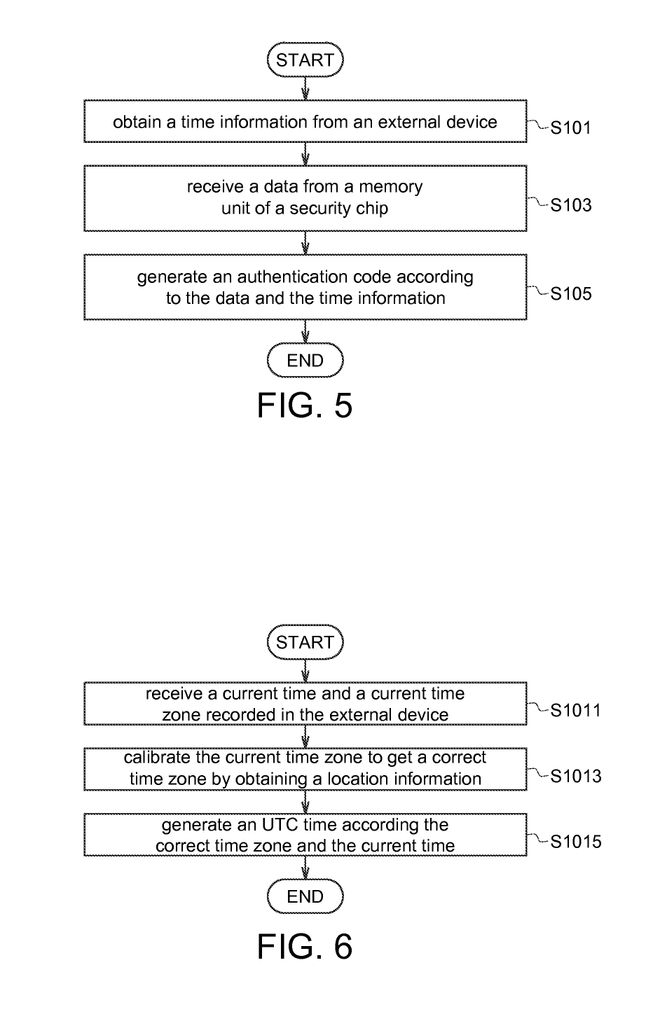

The security chip 103 can generate the authentication code A1 according to the data D1 including a key, some personal data or other secret data from memory unit 1032 and a time information T1 obtained from a mobile device 300. The operation of the security chip 103 is exemplified according to a flow chart shown in FIG. 5.

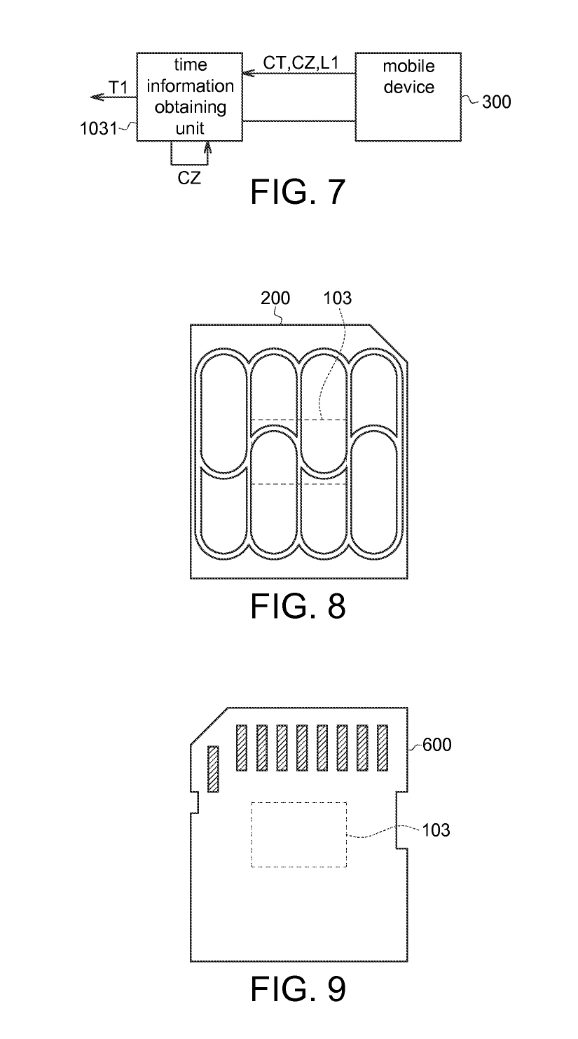

Please referring to FIG. 5, FIG. 5 shows a flow chart of a time information based authentication method. In step S101, referring to FIG. 4 and FIG. 5, the time information obtaining unit 1031 obtains the time information T1 from an external device, e.g. the mobile device 300. In one embodiment, the time information obtaining unit 1031 is connected to a memory of a mobile device 300 to obtain the time information T1. In further, referring to FIG. 6 and FIG. 7, FIG. 6 shows a flow chart of step S101 according to an embodiment of the invention. Step S101 includes steps S1011 to S1015. FIG. 7 is a schematic diagram of the time information obtaining unit 1031 and mobile 300 according to an embodiment of the invention.

In step S1011, the time information obtaining unit 1031 receives a current time CT and a current time zone CZ recorded in the external device, e.g. the mobile device 300. For example, the current time CT and the current time zone CZ are recorded in the memory of the mobile device 300, and the time information obtaining unit 1031 receives the current time CT and the current time zone CZ from the memory of the mobile device 300.

In step S1013, the time information obtaining unit 1031 calibrates the current time zone CZ by obtaining a location information L1 First, the time information obtaining unit 1031 obtains the location information L1. The location information L1 can be a time zone of a place which the base station is located in, hereinafter refers to “base station time zone”. The place is received from the base station by mobile device 300. For example, If the place “Taiwan” which the base station is located in, the place “Taiwan” is received from the base station by mobile device 300, and the location information L1 is the base station time zone “+8”.

In further, the time information obtaining unit 1031 sends a command to the mobile device 300 to request the place which the base station is located in, then the time information obtaining unit 1031 uses the place to search in a lookup table to obtain the base station time zone. The base station time zone is corresponding to the place which the base station is located in. For example, if the place is “Taiwan”, the base station time zone “+8” should be searched out in the lookup table. In one embodiment, the time information obtaining unit 1031 does not send the command to the mobile device 300 to request the place which the base station is located in; instead, the time information obtaining unit 1031 receives the base station time zone from a user interface of the mobile device 300. In this case, the base station time zone is inputted by a user through the user interface.

Then, the time information obtaining unit 1031 calibrates the current time zone CZ to get a correct time zone according to the location information L1. In one embodiment, the time information obtaining unit 1031 determines whether the current time zone CZ obtained in step S1011 should be calibrated or not according to the location information L1, and the time information obtaining unit 1031 calibrates the current time zone CZ according to the location information L1 if the current time zone CZ needs to be calibrated.

For example, the time information obtaining unit 1031 compares the current time zone CZ with the base station time zone. If the current time zone CZ is consistent with the base station time zone, the time information obtaining unit 1031 does not need to calibrate the current time zone CZ. If the current time zone CZ is inconsistent with the base station time zone, the time information obtaining unit 1031 calibrates the current time zone CZ. If the current time zone CZ “+7” is inconsistent with the base station time zone “+8”, the time information obtaining unit 1031 calibrates current time zone CZ “+7” to a correct time zone “+8”.

In step S1015, the time information obtaining unit 1031 generates an Universal Time Coordinated (UTC) time as the time information T1 according to the current time CT and the correct time zone. For example, when the current time CT is “13:00” and correct time zone “+8”, the time information obtaining unit 1031 generates the UTC time “05:00” according to current time CT “13:00” and correct time zone “+8”.

Because of the current time zone CZ received from the mobile device 300 may be wrong, it causes the UTC time generated in step S1015 is also wrong. In order to generating the UTC time which is accurate, the time information obtaining unit 1031 calibrates the current time zone CZ to get the correct time zone according to the location information L1. Accordingly, the accurate UTC time can be generated according to the correct time zone.

In one embodiment, the time information obtaining unit 1031 may be connected to a user interface of a mobile device 300 to obtain the time information T1 in step S101. The user interface may be a touch screen, a key board, a microphone, or a combination thereof. For example, the user can input the time information T1 via a touch screen, and the time information obtaining unit 1031 receives the time information T1 from the touch screen.

In one embodiment, the time information obtaining unit 1031 may be connected to a wireless module of a mobile device 300 to obtain the time information T1 in step S101. The wireless module may be a NFC module, a Wifi module, a Bluetooth module or a QR code module. For example, the user can use the NFC module of the mobile device 300 to read a NFC tag to obtain the time information T1, or to receive the time information T1 from another mobile device, and the time information obtaining unit 1031 receives the time information T1 from the NFC module.

In step S103, the authentication unit 1033 receives the data D1 including a key, some personal data or other secret data from the memory unit 1032. For example, the authentication unit 1033 is connected to the memory unit 1032, and receives the data D1 including a key, some personal data or other secret data from the memory unit 1032.

In step S105, the authentication unit 1033 generates the authentication code A1 according to the data D1 and the time information T1. For example, the authentication unit 1033 is connected to the time information obtaining unit 1031, and receives the time information T1 from the time information obtaining unit 1031. Then, the authentication unit 1033 generates the authentication code A1 according to the data D1 and the time information T1. After generating the authentication code A1, the authentication code A1 is sent to the server 500 to perform an authentication procedure.

FIG. 8 is a schematic diagram of the SIM card 200 according to an embodiment of the invention. In one embodiment, the security chip 103 can be integrated into the SIM card 200 so that the SIM card 200 has a time information based authentication function, and can perform steps S101 to S105 and steps S1011 to S1015. For example, after the security chip 103 is integrated into the SIM card 200, the SIM card 200 includes the time information obtaining unit 1031, the memory unit 1032 and the authentication unit 1033. The memory unit 1032 stores the data, the data include the key and the personal information of the account holder, including his or her phone number, address book, text messages, and other secret data. The detail of performing steps S101 to S105 and steps S1011 to 51015 by the SIM card 200 is similar to the detail of performing the same steps by the security chip 103.

FIG. 9 is a schematic diagram of a secure digital (SD) card 600 according to an embodiment of the invention. In one embodiment, the security chip 103 can be integrated into the SD card 600 so that the SD card 600 has a time information based authentication function, and can perform steps S101 to S105 and steps S1011 to S1015. For example, after the security chip 103 is integrated into the SD card 600, the SD card 600 includes the time information obtaining unit 1031, the memory unit 1032 and the authentication unit 1033. The memory unit 1032 stores the data including the key, personal information or other secret data. The detail of performing steps S101 to S105 and steps S1011 to S1015 by the SD card 600 is similar to the detail of performing the same steps by the security chip 103.

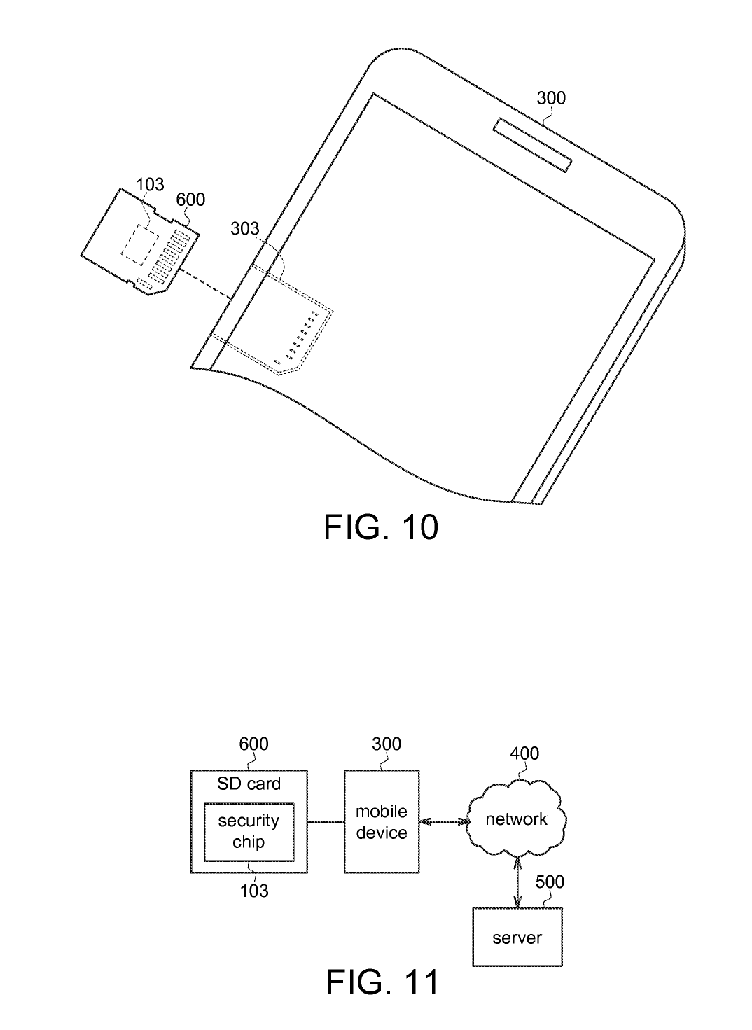

FIG. 10 shows the SD card 600 and the mobile device 300 according to an embodiment of the invention. The mobile device 300 includes a SD card slot 303. The security chip 103 is integrated into the SD card 600, and the SD card 600 is put into the SD card slot 303 of the mobile device 300.

Please referring to FIG. 11, FIG. 11 shows a relation diagram among the security chip 103, the SD card 600, the mobile device 300 and the server 500 according to an embodiment of the invention. The security chip 103 is integrated into the SD card 600. The mobile device 300 may communicate with the server 500 through the network 400. The server 500 may be an authentication server. In one embodiment, the security chip 103 may generate the authentication code, and may send the authentication code to server 500 to perform the authentication procedure. In another embodiment, the security chip 103 may generate the authentication code, and may display on the screen of the mobile device 300. Then, the user may input the authentication code in the computer system (not shown) which is connected to the server 500, to perform the authentication procedure.

Base on the above, the security chip can generate an authentication code based on the data and the time information which is obtained from a mobile device. Because the time information is unique, the security of performing an authentication on the mobile device is improved.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A time information based authentication method, comprising:
obtaining a time information from an external device;
receiving a data from a memory unit of a security chip; and
generating an authentication code according to the data and the time information.

2. The time information based authentication method according to claim 1, wherein the step of obtaining the time information from the external device comprises:
receiving a current time and a current time zone recorded in the external device;
calibrating the current time zone to get a correct time zone by obtaining a location information; and
generating an UTC time according the correct time zone and the current time.

3. The time information based authentication method according to claim 2, wherein the location information is a base station time zone, and the base station time zone is corresponding to a place which a base station is located in.

4. The time information based authentication method according to claim 1, wherein the step of obtaining the time information from the external device comprises:
providing a user interface; and
receiving the time information from the user interface.

5. The time information based authentication method according to claim 1, wherein the step of obtaining the time information from the external device comprises:
receiving the time information from a wireless module of the external device.

6. The time information based authentication method according to claim 1, wherein the external device is a mobile device.

7. An integrated circuit having a time information based authentication function, the integrated circuit comprising:
a security chip, comprising:
a time information obtaining unit for obtaining a time information from an external device;
a memory unit for storing a data; and
an authentication unit for receiving the data from the memory unit, and generating an authentication code according to the data and the time information.

8. The integrated circuit according to claim 7, wherein the integrated circuit is an integrated circuit film, the integrated circuit further comprises:
a circuit board having a first surface and a second surface opposite to the first surface;
a plurality of first pads located on the first surface for connecting to the external device; and
a plurality of second pads located on the second surface for connecting to a SIM card;
wherein the security chip is mounted on the circuit board for communicating with the external device through the first pads, and communicating with the SIM card through the second pads.

9. The integrated circuit according to claim 7, wherein the integrated circuit is a Subscriber Identity Module (SIM) card, and the data includes a key, a phone number, an address book, text messages and other secret information.

10. The integrated circuit according to claim 7, wherein the integrated circuit is a Secure Digital (SD) card, and the data includes a key, personal information or secret information.

11. The integrated circuit according to claim 7, wherein the external device is a mobile device.

12. The integrated circuit according to claim 7, wherein the time information obtaining unit receives a current time and a current time zone recorded in the external device, calibrates the current time zone to get a correct time zone by obtaining a location information, and generates an UTC time according to the correct time zone and the current time.

13. The integrated circuit according to claim 12, wherein the location information is a base station time zone, and the base station time zone is corresponding to a place which a base station is located in.

14. The integrated circuit according to claim 7, wherein the time information obtaining unit is connected to a user interface of the external device, and receives the time information from the user interface.

15. The integrated circuit according to claim 7, wherein the time information obtaining unit is connected to a wireless module of the external device, and receives the time information from the wireless module.
